(19) United States
(12) Patent Application Publication
(10) Pub. No.: US 2017/0312667 A1
(43) Pub. Date: Nov. 2, 2017

(54) Filtering Device for Erosion Control and Reducing Contamination

(71) Applicants: Perry R. Burt, Cambridge, OH (US); Joe O. Greco, Atlantic, PA (US); James Elkin, Shelocta, PA (US)

(72) Inventors: Perry R. Burt, Cambridge, OH (US); Joe O. Greco, Atlantic, PA (US); James Elkin, Shelocta, PA (US)

(21) Appl. No.: 15/585,126

(22) Filed: May 2, 2017

Related U.S. Application Data
(60) Provisional application No. 62/330,679, filed on May 2, 2016.

(51) Int. Cl. B01D 35/30; B01D 39/16; E03F 5/04; B01D 29/31; B01D 29/35; C02F 1/00; C02F 103/00

(52) U.S. Cl. CPC B01D 35/30; B01D 29/35; B01D 39/1615; C02F 1/004; E03F 5/041; B01D 29/31; B01D 2201/302; B01D 2201/325; C02F 2103/001; B01D 2201/31

(57) ABSTRACT

A filtering device for reducing radiation, sediment, contamination, pollution, and erosion control contains a first flow plate, a second flow plate, a tubular portion, and a biodegradable filtering material. The first flow plate is terminally connected to a first end of the tubular portion. A plurality of openings of the first flow plate allows water to enter the tubular portion. The second flow plate is terminally connected to a second end of the tubular portion. A plurality of openings of the second flow plate allows water to exit the tubular portion. The biodegradable filtering material is integrated within the tubular portion so that water entering the tubular portion at the first end is filtered prior to exiting the tubular portion at the second end. Switchgrass is utilized as the biodegradable filtering material.

The current application claims a priority to the U.S. Provisional Patent application Ser. No. 62/330,679 filed on May 2, 2016.

### FIELD OF THE INVENTION

The present invention relates generally to a filtering device. More specifically, the present invention is a filtering device that can be used to reduce radiation, sediment, contamination, slow the flow of storm water, and control erosion.

### BACKGROUND OF THE INVENTION

Different methods are used to control the flow of storm water and control soil erosion. Planting grass and shrubs, adding mulch or rocks, using mulch matting to hold vegetation slopes, laying out fiber logs, and building retainer walls are some of the most common methods used for erosion control. Even though these methods have significant benefits, there are certain drawbacks that need to be addressed as well.

Most traditional sediment control methods require trenching. As a result, the overall soil surface is disturbed. A disturbed soil surface can be extremely concerning in areas with a steep slope. Therefore, there is a clear need for a method that can be used for erosion control without disturbing the overall soil surface.

The financial burden and the time-consuming nature is another disadvantage of traditional sediment control methods. As an example, if a retainer wall was to be built on a slope, a considerable time period needs to be allocated along with a considerable financial investment. Hence, a financially beneficial method of sediment control is needed. Moreover, a solution that can be implemented within a short time period is clearly needed.

The objective of the present invention is to address the aforementioned issues. More specifically, the present invention is a filtering device specifically designed to control erosion and contain and/or retain sediment in disturbed areas. The filtering functionalities of the present invention retains sediments and other pollutants such as suspended solids, tannic acid, nitrates, phosphates and motor oil. As an end result, the present invention allows clean water to flow through to creeks and streams

### BRIEF DESCRIPTION OF THE DRAWINGS

FIG. 1 is a perspective view of the present invention.

FIG. 2 is a side view of the present invention, wherein an inner surface of the tubular portion and the biodegradable filtering material are also illustrated.

FIG. 3 is an exploded perspective view of the present invention.

FIG. 4 is a side view of the present invention, wherein the tubular portion is perforated.

FIG. 5 is a side view of the present invention, wherein the tubular portion comprises an outlet flange.

FIG. 6 is an exploded view of the present invention illustrating the fastening mechanism.

FIG. 7 is another exploded view of the present invention illustrating the fastening mechanism.

### DETAIL DESCRIPTIONS OF THE INVENTION

All illustrations of the drawings are for the purpose of describing selected versions of the present invention and are not intended to limit the scope of the present invention.

The present invention introduces a filtering device that can be used for reducing radiation, sediment, contamination, pollution, and for controlling erosion. In addition to the filtering functionalities, the biodegradable material used for filtering also helps reduce radiation. When compared to traditional sediment control and soil erosion prevention techniques, the present invention introduces a method that is affordable and effective over an extended period.

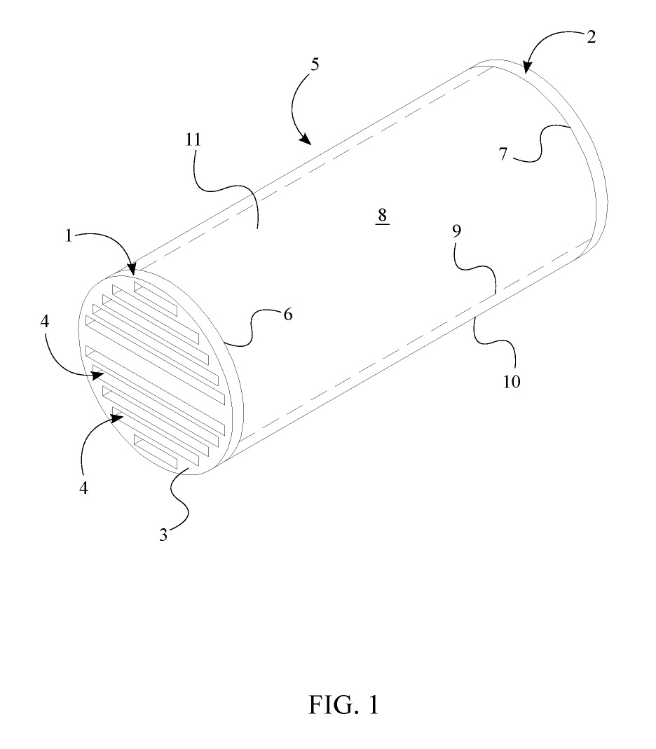

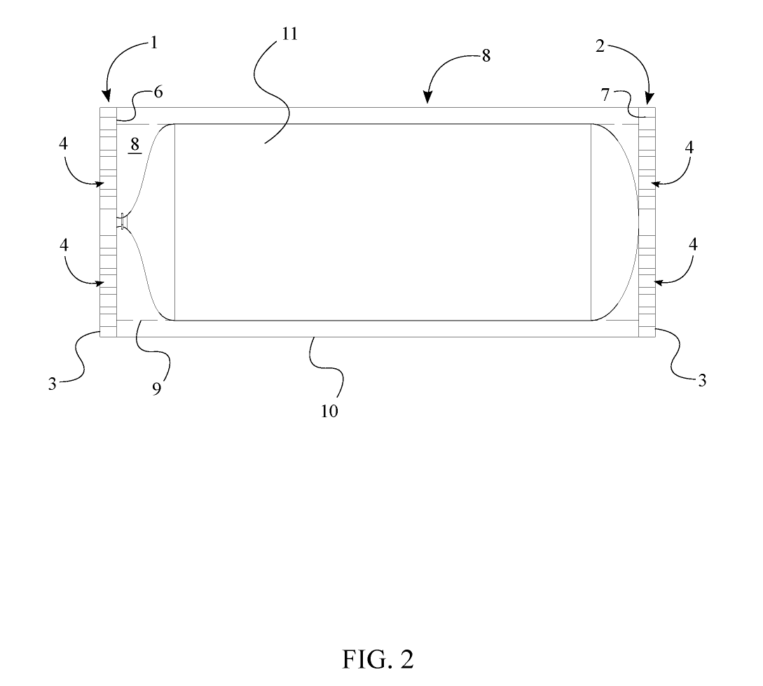

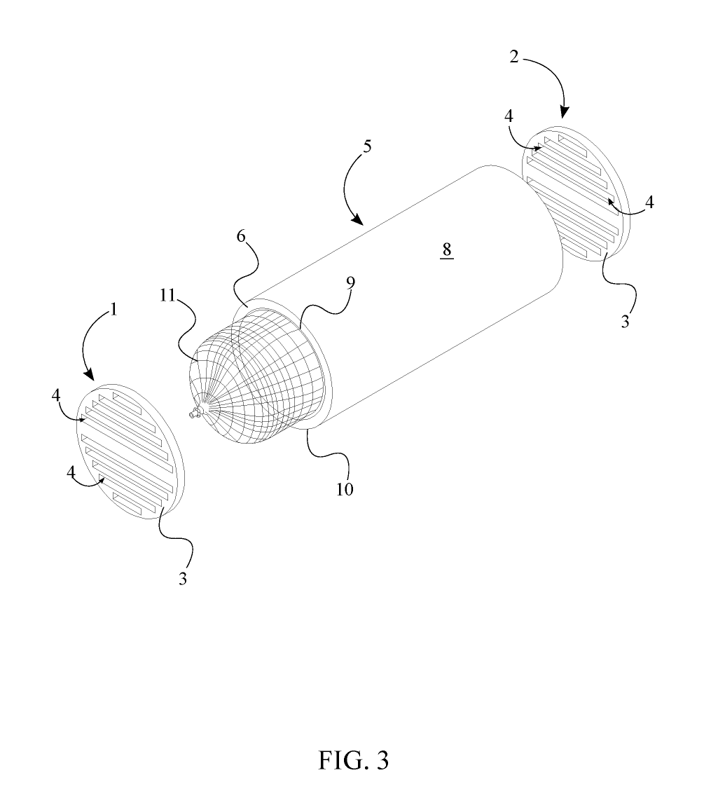

As illustrated in FIGS. 1-3, the present invention comprises a first flow plate 1, a second flow plate 2, a tubular portion 5, and a biodegradable filtering material 11. The first flow plate 1 functions as an inlet for the water flow. On the other hand, the second flow plate 2 functions as an outlet for the water flow. In other words, the water that enters the present invention through the first flow plate 1 is filtered and sent out of the second flow plate 2. The tubular portion 5, which is the structural frame of the present invention holds the first flow plate 1 and the second flow plate 2. Furthermore, the tubular portion 5 functions as a guide for the water flow from the first flow plate 1 to the second flow plate 2. The size, shape, and other materialistic properties of the tubular portion 5 can vary from one embodiment to another. Depending on the application of the present invention, the tubular portion 5 can be of a pipe, container or other comparable apparatus. The biodegradable filtering material 11 is used to retain sediments and other pollutants such as suspended solids, tannic acids, nitrates, phosphates, motor oil and other comparable pollutants.

As seen in FIGS. 1-7, to allow water to pass through, the first flow plate 1 and the second flow plate 2 each comprises a plate body 3 and a plurality of openings 4. The plate body 3 provides structural strength to the first flow plate 1 and the second flow plate 2. To do so, the first flow plate 1 and the second flow plate 2 are preferably manufactured from stainless steel or high-density polyethylene (HDPE). The material used for manufacturing the first flow plate 1 and the second flow plate 2 is important when considering the environmental conditions the present invention is being used in and the durability of the present invention. In other words, the first flow plate 1 and the second flow plate 2 need to be made of a material that can withstand the moisture and other relatable environmental conditions the present invention is being used in. The overall size and shape of the first flow plate 1 and the second flow plate 2 can vary from one embodiment to another. Since the first flow plate 1 and the second flow plate 2 are intended to work in conjunction with the tubular portion 5, the overall size and shape of the first flow plate 1 and the second flow plate 2 is dependent on the size and shape of the tubular portion 5. Generally, the first flow plate 1 and the second flow plate 2 will be circular in shape.

The plurality of openings 4 allows water to pass through the plate body 3 of the first flow plate 1 and the second flow plate 2. To do so, the plurality of openings 4 traverse through the plate body 3. Each of the plurality of openings 4 are equidistantly positioned with each other along a surface area of the plate body 3. Moreover, the size and shape of each of the plurality of openings 4 can vary in different embodiments of the present invention. As an example, in one embodiment of the present invention, each of the plurality of openings 4 can be rectangular in shape. In another embodiment of the present invention, each of the plurality of openings 4 can be oval shaped.

As discussed earlier, the tubular portion 5 functions as a guide for the water flow from the first flow plate 1 to the second flow plate 2. To work in conjunction with the first flow plate 1 and the second flow plate 2, the tubular portion 5 comprises a first end 6, a second end 7, a body 8, an inner surface 9, and an outer surface 10. The body 8 extends from the first end 6 to the second end 7 and in between the inner surface 9 and the outer surface 10. In other words, an overall length of the tubular portion 5 is given by a distance determined by the first end 6 and the second end 7. Moreover, an overall thickness of the tubular portion 5 is given by a distance determined by the inner surface 9 and the outer surface 10. Preferably, the tubular portion 5 is manufactured from polyvinyl chloride (PVC) or a comparable material. However, the size, shape and other materialistic properties of the tubular portion 5 can vary from one embodiment to another. For the present invention to be used in a wide variety of environments, the tubular portion 5 is preferably made of flexible material. The flexibility allows the present invention to adjust according to the surface the present invention is being used on. As an example, if the present invention is being used on a slope, the flexibility allows the present invention to contour the slope. Thus, the soil of the slope and surrounding areas are not disturbed when the present invention is being used.

To execute the filtering process, the first flow plate 1 is terminally connected to the tubular portion 5 at the first end 6. More specifically, the first flow plate 1 is concentrically aligned with an opening of the tubular portion 5 at the first end 6. The connection between the first flow plate 1 and the tubular portion 5 ensures that water enters the tubular portion 5 at a reduced speed through the first flow plate 1. To filter the water within the tubular portion 5, the biodegradable filtering material 11 is positioned within the body 8 along the inner surface 9 from the first end 6 to the second end 7. In the preferred embodiment of the present invention, switchgrass is used as the biodegradable filtering material 11. Therefore, the present invention can be used to filter out any impurities filtered out by switchgrass. To effectively filter out impurities, the water needs to travel through the tubular portion 5 at a controlled speed. Moreover, the filtered water needs to exit the tubular portion 5 at a controlled speed. To do so, the second flow plate 2 is terminally connected to the tubular portion 5 at the second end 7. In general, the contaminated water that enters the tubular portion 5 through the first flow plate 1, is filtered with the biodegradable filtering material 11, and exits the tubular portion 5 at the second flow plate 2 at a reduced and controlled speed.

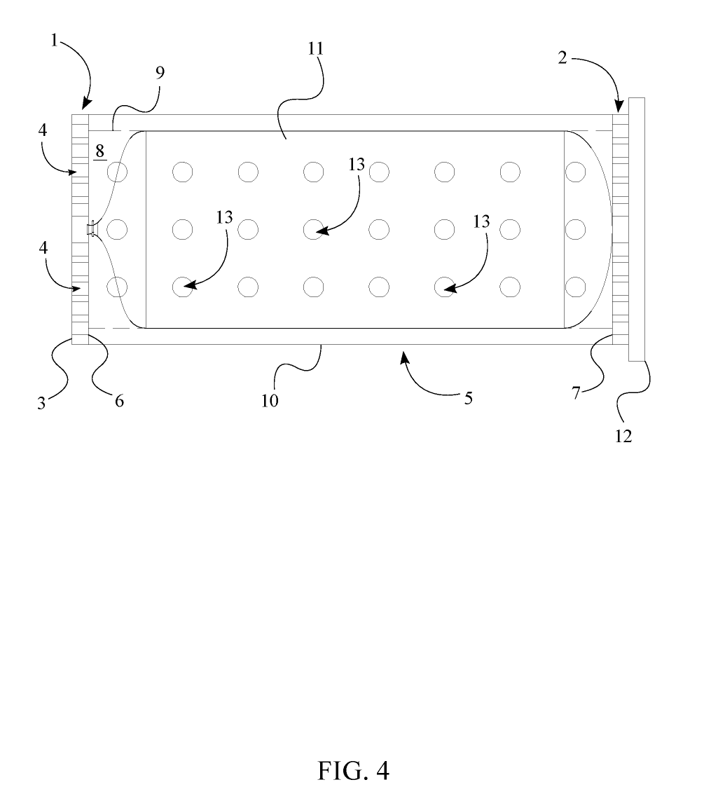

The effective design of the present invention allows the present invention to be used as a leaching filter in one embodiment of the present invention. By doing so, the flow of storm water flowing into creeks and streams is controlled. Additionally, the water is filtered from any potential sediments, pollutants, oils, and other comparable matter which is beneficial in protecting wildlife. To do so, the present invention further comprises a blinding flange 12 and the tubular portion 5 further comprises a plurality of perforations 13 as illustrated in FIG. 4. The blinding flange 12 is used to block the outflow of water via the second flow plate 2. To effectively block the second flow plate 2, the blinding flange 12 is hingedly connected to the tubular portion 5 adjacent to the second flow plate 2. Even through the blinding flange 12 is hingedly connected to the tubular portion 5 in the preferred embodiment of the present invention, a different attachment mechanism can be used if the overall functionality remains unchanged. The plurality of perforations 13 is used as an outlet for the water that is blocked with the use of the blinding flange 12. To do so, the plurality of perforations 13 traverse into the body 8 from the outer surface 10 to the inner surface 9. Therefore, the water trapped within the tubular portion 5 gets filtered and seeps through the plurality of perforations 13 at a controlled and reduced rate. To effectively release the entire volume of water trapped within the tubular portion 5, the plurality of perforations 13 is distributed along the body 8 from the first end 6 to the second end 7. To promptly access the biodegradable filtering material 11 and replace the biodegradable filtering material 11, the blinding flange 12 is used as an access point. More specifically, the blinding flange 12 is swung open at the hinged connection so that the biodegradable filtering material 11 can be installed or replaced.

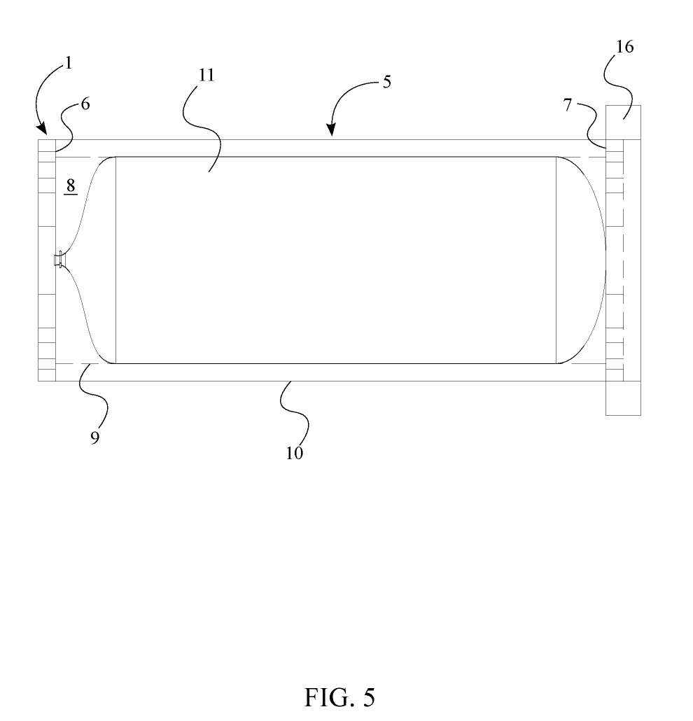

As seen in FIGS. 5-7, the effective design allows the present invention to be integrated into a culvert system so that the overall water flow from the culvert is controlled and impurities are reduced or removed. In doing so, the tubular portion 5 further comprises an outlet flange 16 which is terminally connected to the body 8 at the second end 7. More specifically, the second flow plate 2 and the outlet flange 16 are concentric to each other. Similar to being used in a culvert system, the present invention can also be used as an in-line filtering device installed into a piping system.

The present invention further comprises a fastening mechanism 17 which is used to hold the first flow plate 1 and the second flow plate 2 on either side of the tubular portion 5. More specifically, the first flow plate 1 and the second flow plate 2 are removably attached to the tubular portion 5 through the fastening mechanism 17. The fastening mechanism 17 also ensures that the biodegradable filtering material 11 is positioned in between the first flow plate 1 and the second flow plate 2.

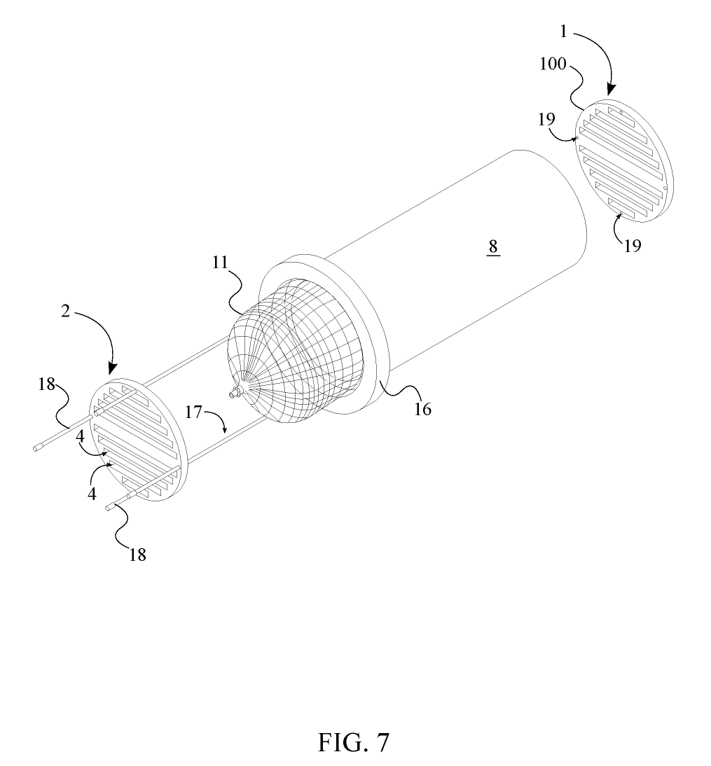

The fastening mechanism 17 can vary from one embodiment to another. As illustrated in FIG. 7, if the present invention is integrated into a culvert system, the fastening mechanism 17 comprises at least one fastening screw 18. In such instances, the first flow plate 1 and the second flow plate 2 each comprise at least one screw-receiving hole 19. The at least one screw-receiving hole 19 traverses the first flow plate 1 and the second flow plate 2 adjacent to a perimeter 100 of the first flow plate 1 and the second flow plate 2. When attaching, the at least one fastening screw 18 is removably positioned into the at least one screw-receiving hole of the first flow plate 1 and the second flow plate 2.

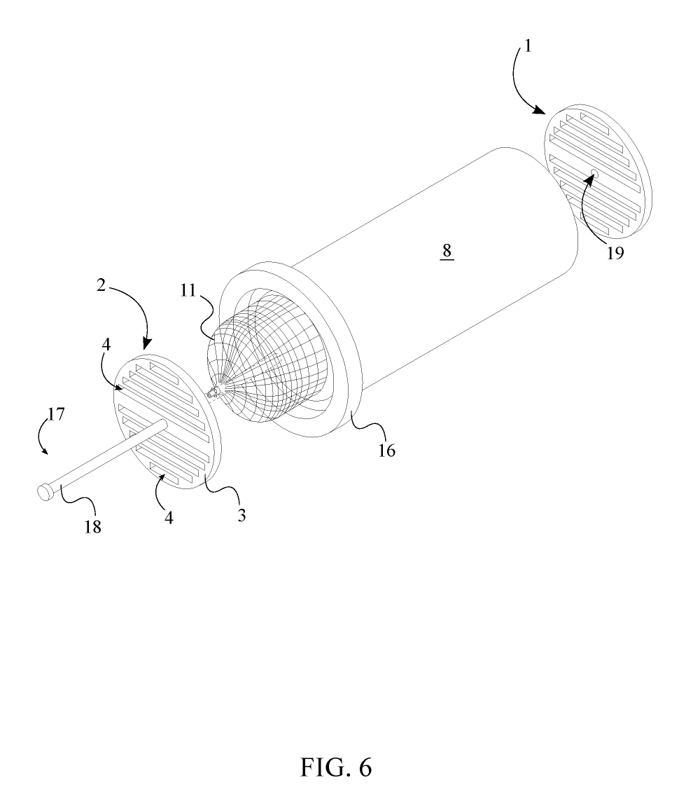

In another embodiment, if the present invention is use as an in-line filtering device, the at least one screw-receiving hole 19 centrally traverses through the first flow plate 1 and the second flow plate 2 as shown in FIG. 6. The at least one fastening screw 18 is removably positioned into the at least one screw receiving hole so that the first flow plate 1 and the second flow plate 2 are held together.

Although the invention has been explained in relation to its preferred embodiment, it is to be understood that many other possible modifications and variations can be made without departing from the spirit and scope of the invention as hereinafter claimed.

What is claimed is:

1. A filtering device for reducing radiation, sediment, contamination, pollution, and erosion control comprises:
a first flow plate;
a second flow plate;
a tubular portion;
a biodegradable filtering material;
the first flow plate and the second flow plate each comprise a plate body and a plurality of openings;
the tubular portion comprises a first end, a second end, a body, an inner surface, and an outer surface;
the plurality of openings traversing through the plate body;
the body extending from the first end to the second end, wherein the body extends in between the outer surface and the inner surface;
the first flow plate being terminally connected to the tubular portion at the first end;
the second flow plate being terminally connected to the tubular portion at the second end; and
the biodegradable filtering material being positioned within the body along the inner surface from the first end to the second end.

2. The filtering device for reducing radiation, sediment, contamination, pollution, and erosion control as claimed in claim 1, wherein the biodegradable filtering material is switchgrass.

3. The filtering device for reducing radiation, sediment, contamination, pollution, and erosion control as claimed in claim 1, wherein the tubular portion is made of a flexible material.

4. The filtering device for reducing radiation, sediment, contamination, pollution, and erosion control as claimed in claim 1 further comprises:
a blinding flange;
the tubular portion further comprises a plurality of perforations;
the blinding flange being hingedly connected to the tubular portion adjacent to the second flow plate;
the plurality of perforations traversing into the body from the outer surface to the inner surface; and
the plurality of perforations being distributed along the body from the first end to the second end.

5. The filtering device for reducing radiation, sediment, contamination, pollution, and erosion control as claimed in claim 1 further comprises:
the tubular portion further comprises an outlet flange; and
the outlet flange being terminally connected to the body at the second end.

6. The filtering device for reducing contamination, pollution, and erosion control as claimed in claim 1, wherein the first flow plate and the second flow plate are removably attached to the tubular portion through a fastening mechanism.

7. The filtering device for reducing radiation, sediment, contamination, pollution, and erosion control as claimed in claim 6 further comprises:
at least one fastening screw;
the first flow plate and the second flow plate each comprise at least one screw-receiving hole;
the at least one screw-receiving hole traversing the first flow plate and the second flow plate adjacent to a perimeter of the first flow plate and the second flow plate; and
the at least one fastening screw being removably positioned into the at least one screw-receiving hole of the first flow plate and the second flow plate.

8. The filtering device for reducing radiation, sediment, contamination, pollution, and erosion control as claimed in claim 6 further comprises:
at least one fastening screw;
the first flow plate and the second flow plate each comprise at least one screw-receiving hole;
the at least one screw-receiving hole centrally traversing through the first flow plate and the second flow plate; and
the at least one fastening screw being removably positioned into the at least one screw-receiving hole for the first flow plate and the second flow plate.

9. The filtering device for reducing radiation, sediment, contamination, pollution, and erosion control as claimed in claim 1, wherein each of the plurality of openings are equidistantly positioned with each other.

10. The filtering device for reducing radiation, sediment, contamination, pollution, and erosion control as claimed in claim 1, wherein the first flow plate and the second flow plate are manufactured from stainless steel.

11. The filtering device for reducing radiation, sediment, contamination, pollution, and erosion control as claimed in claim 1, wherein the first flow plate and the second flow plate are manufactured from high-density polyethylene (HDPE).
